(19) United States
(12) Patent Application Publication
(10) Pub. No.: US 2026/0163349 A1
(43) Pub. Date: Jun. 11, 2026

(54) HARNESS HOLDER AND IMAGE FORMING APPARATUS

(71) Applicants: Ryoh ISHITSUKA, Kanagawa (JP); Ryotaro MIMA, Kanagawa (JP)

(72) Inventors: Ryoh ISHITSUKA, Kanagawa (JP); Ryotaro MIMA, Kanagawa (JP)

(73) Assignee: Ricoh Company, Ltd., Ohta-ku, Tokyo (JP)

(21) Appl. No.: 19/354,427

(22) Filed: Oct. 9, 2025

(30) Foreign Application Priority Data
Dec. 9, 2024 (JP) 2024-214284
Jul. 31, 2025 (JP) 2025-128403

(51) Int. Cl. H02G 3/32; G03G 15/00

(52) U.S. Cl. CPC H02G 3/32; G03G 15/80; G03G 2215/00978

(57) ABSTRACT

A harness holder includes a harness clamp and a planar base. The harness clamp has a shaft and a clamp portion to clamp a harness. The base has a shaft hole and a raised portion. The shaft hole is used to insert the shaft of the harness clamp. The raised portion has a part bent and raised from the planer base. The harness clamp attached to the planer base is rotatable about the shaft. The raised portion is disposed within a rotation range of the harness clamp on the planer base.

### CROSS-REFERENCE TO RELATED APPLICATIONS

This patent application is based on and claims priority pursuant to 35 U.S.C. § 119(a) to Japanese Patent Application Nos. 2024-214284, filed on Dec. 9, 2024, and 2025-128403, filed on Jul. 31, 2025, in the Japan Patent Office, the entire disclosure of each of which is hereby incorporated by reference herein.

### BACKGROUND

### Technical Field

Embodiments of the present disclosure relate to a harness holder and an image forming apparatus incorporating the harness holder.

### Related Art

Various harnesses that supply the power and transmit signals are laid out inside an image forming apparatus such as a copier, a printer, a facsimile machine, or a multifunctional peripheral including the functions of the copier, printer and facsimile machine, or different electronic devices. In order to prevent the harnesses from contacting a non-contactable member such as a movable portion inside a device, a routing path (wiring path) of the harnesses is restricted by a harness clamp.

A typical harness clamp has a holding portion that holds a harness and a shaft that is integrated with the holding portion and is inserted into an attachment hole formed in a base of a device, such as a cable clamp disclosed in a harness holder in the related art. The harness clamp is supported so as to be rotatable about a shaft to provide a wiring path with a margin. A restrictor to restrict a rotation range of the harness clamp is disposed on a side of the attachment hole.

A typical restrictor is a different member separate from a base and is attached to the base with, for example, screws or glue. In a case where such a restrictor as a different member, an issue of an increase in cost due to an increase in the number of parts and the attaching steps arises.

### SUMMARY

Embodiments of the present disclosure described herein provide a novel harness holder including a harness clamp and a planar base. The harness clamp has a shaft and a clamp portion to clamp a harness. The base has a shaft hole and a raised portion. The shaft hole is used to insert the shaft of the harness clamp. The raised portion has a part bent and raised from the planer base. The harness clamp attached to the planer base is rotatable about the shaft. The raised portion is disposed within a rotation range of the harness clamp on the planer base.

Further, embodiments of the present disclosure described herein provide an image forming apparatus including the above-described harness holder.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A-a is a plan view of a harness holder according to the present disclosure;

FIG. 1A-b is a side view of the harness holder of FIG. 1A-a;

FIG. 1A-c is a front view of the harness holder of FIG. 1A-a;

FIG. 1B-a is a plan view of a harness holder in a state where a range of rotation of a harness clamp of FIG. 1A-a is restricted;

FIG. 1B-b is a side view of the harness holder of FIG. 1B-a;

FIG. 1B-c is a front view of the harness holder of FIG. 1B-a;

FIG. 2 is a plan view of a base;

FIG. 3A is a side view of a harness clamp when the harness clamp is open;

FIG. 3B is a side view of a harness clamp when the harness clamp is closed;

FIG. 4A-a is a plan view of a base according to a modification of the embodiments;

FIG. 4A-b is a side view of the base of FIG. 4A-a;

FIG. 4A-c is a front view of the base of FIG. 4A-a;

FIG. 4B-a is a plan view of a base according to a modification of the embodiments when a harness clamp is attached to the base;

FIG. 4B-b is a side view of the base of FIG. 4B-a; FIG. 4B-c is a front view of the base of FIG. 4B-a;

FIGS. 5A and 5B are diagrams each illustrating a relation of the height of a raised portion of a base and a harness;

FIG. 6A-a is a plan view of a base having a raised portion according to a modification of the embodiments;

FIG. 6A-b is a side view of the base of FIG. 6A-a;

FIG. 6A-c is a front view of the base of FIG. 6A-a;

FIG. 6B-a is a plan view of a base with a harness clamp attached;

FIG. 6B-b is a side view of the base of FIG. 6B-a;

FIG. 6B-c is a front view of the base of FIG. 6B-a;

FIG. 7A-a is a plan view of a base having a raised portion according to a modification of the embodiments;

FIG. 7A-b is a side view of the base of FIG. 7A-a;

FIG. 7A-c is a front view of the base of FIG. 7A-a;

FIG. 7B-a is a plan view of a base with a harness clamp attached;

FIG. 7B-b is a side view of the base of FIG. 7B-a;

FIG. 7B-c is a front view of the base of FIG. 7B-a;

FIG. 8A-a is a plan view of a base having a raised portion according to a modification of the embodiments;

FIG. 8A-b is a side view of the base of FIG. 8A-a;

FIG. 8A-c is a front view of the base of FIG. 8A-a;

FIG. 8B-a is a plan view of a base with a harness clamp attached;

FIG. 8B-b is a side view of the base of FIG. 8B-a;

FIG. 8B-c is a front view of the base of FIG. 8B-a;

FIG. 9A-a is a plan view of a base having a raised portion according to a modification of the embodiments;

FIG. 9A-b is a side view of the base of FIG. 9A-a;

FIG. 9A-c is a front view of the base of FIG. 9A-a;

FIG. 9B-a is a plan view of a base with a harness clamp attached;

FIG. 9B-b is a side view of the base of FIG. 9B-a;

FIG. 9B-c is a front view of the base of FIG. 9B-a;

FIG. 10A is a plan view of a base with a harness clamp of a different size;

FIG. 10B is a side view of the base of FIG. 10A;

FIG. 10C is a front view of the base of FIG. 10A;

FIG. 11A is a plan view of a harness holder on a side of a non-contactable member;

FIG. 11B is a side view of the harness holder of FIG. 11A;

FIG. 12A-a is a plan view of a base according to a modification of the embodiments;

FIG. 12A-b is a side view of the base of FIG. 12A-a;

FIG. 12A-c is a front view of the base of FIG. 12A-a;

FIG. 12B is a plan view of a base with a harness clamp attached;

FIG. 13A-a is a plan view of a base according to a modification of the embodiments;

FIG. 13A-b is a side view of the base of FIG. 13A-a;

FIG. 13A-c is a front view of the base of FIG. 13A-a;

FIG. 13B is a plan view of a base with a harness clamp attached;

FIGS. 14A and 14B are perspective views of a motor including a harness holder according to an embodiment of the present disclosure; and

FIG. 15 is a diagram illustrating an overall configuration of an image forming apparatus including a harness holder according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A description is given below of a harness holder according to an embodiment of the present disclosure with reference to the drawings. It is to be understood that the harness holder or harness holding structure illustrated in the drawings is exemplary and not limiting.

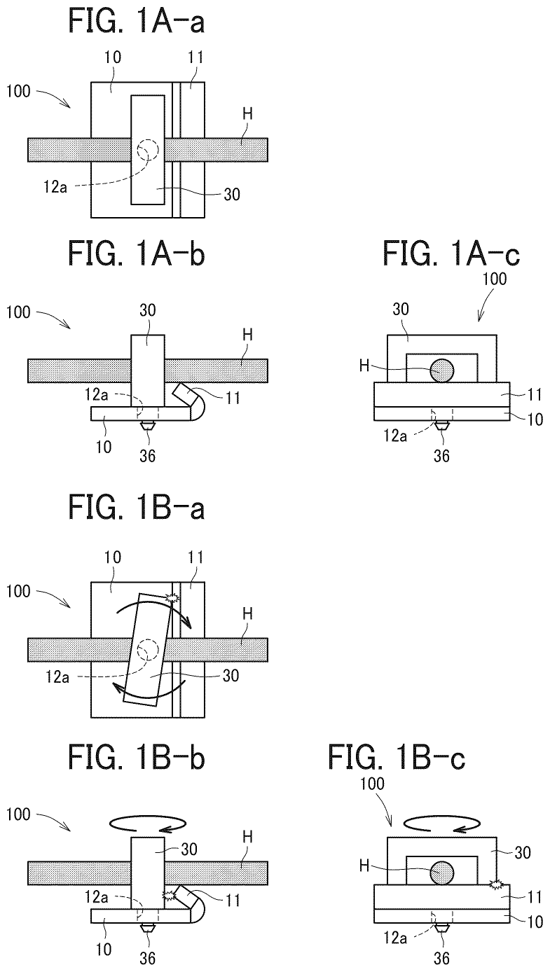

FIG. 1A-a is a plan view of a harness holder according to the present disclosure.

FIG. 1A-b is a side view of the harness holder of FIG. 1A-a.

FIG. 1A-c is a front view of the harness holder of FIG. 1A-a.

FIG. 1B-a is a plan view of a harness holder in a state where a range of rotation of a harness clamp of FIG. 1A-a is restricted.

FIG. 1B-b is a side view of the harness holder of FIG. 1B-a.

FIG. 1B-c is a front view of the harness holder of FIG. 1B-a.

As illustrated in FIGS. 1A-a, 1A-b, 1A-c, 1B-a, 1B-b, and 1B-c, a harness holding structure 100 as a harness holder according to an embodiment of the present disclosure includes a base 10 and a harness clamp 30. The base 10 is a planar base. The harness clamp 30 is rotatably supported on the base 10. A harness H routed on the base 10 is held (clamped) by the harness clamp 30, so that the wiring path of the harness H is restricted.

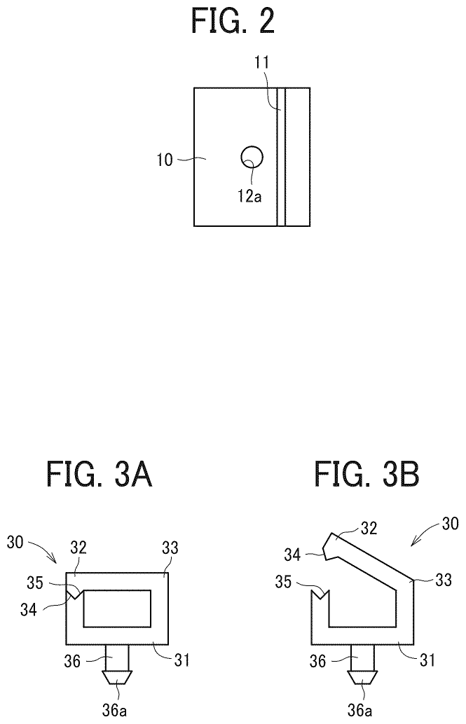

FIG. 2 is a plan view of the base 10.

As illustrated in FIG. 2, the base 10 is a rectangular plate made of, for example, sheet metal. One end of the base 10 is bent upward in a V-shape (at an acute angle). Due to this configuration, the raised portion 11 standing or bent upward from the base 10 is formed on the one end of the base 10.

The raised portion 11 is located in a range of rotation of the harness clamp 30 about a shaft 36 of the harness clamp 30. This configuration can avoid adding a separate part is not disposed to restrict the rotation of the harness clamp 30 or using a separate clamp having a specific structure to restrict the rotation. Accordingly, this configuration can prevent an increase in cost due to an increase in the number of parts and components and the attaching steps, and restrict the rotation of the harness clamp 30 with an inexpensive configuration.

The raised portion 11 extends linearly along one side of the base 10 in a plan view. One shaft hole 12a penetrating the base 10 in the vertical direction is formed in the vicinity of the central portion in the longitudinal direction of the raised portion 11.

The raised portion 11 has a height, from the planer base 10. In other words, the raised portion 11 is higher than a lower edge of the main body 31 (clamp portion) of the harness clamp 30 having the shaft 36 inserted into the shaft hole 12a of the planer base 10 and lower than a lower edge of the harness H clamped by the harness clamp 30.

FIG. 3A is a side view of the harness clamp 30 when the harness clamp 30 is open.

FIG. 3B is a side view of the harness clamp 30 when the harness clamp 30 is closed.

As illustrated in FIGS. 3A and 3B, the harness clamp 30 has a shaft 36 having a cylindrical shape. The shaft 36 is rotatably inserted into the shaft hole 12a of the base 10 in a downward direction.

The tip portion 36a of the shaft 36 is formed in an umbrella shape (truncated conical shape) for preventing the shaft 36 from coming off from the base 10. The shaft 36 is preferably cylindrical, but may be other than cylindrical, such as prismatic or elliptical.

The harness clamp 30 includes a U-shaped main body 31 having the shaft 36 formed on a lower face of the main body 31, a receiving portion 35 formed of a V-shaped cutout portion formed on one end of the main body 31, and a cap 32 that can be moved up and down (opened and closed) about a hinge 33 on the opposite side of the main body 31. The main body 31 and the cap 32 may be formed in an arc shape corresponding to the outer shape of the harness H.

A V-shaped protruding portion 34 is formed at the tip of the cap 32. After the harness H is accommodated inside the main body 31 of the harness clamp 30, the cap 32 is closed and the protruding portion 34 is fitted to the receiving portion 35, so that the harness H can be positioned inside the main body 31.

A slight gap is formed between the harness clamp 30 and the raised portion 11. The gap allows the harness clamp 30 to rotate about the shaft 36 at a small angle.

Since the rotation of the harness clamp 30 at a small angle is allowed in this manner, a certain degree of allowance is created in the wiring path of the harness H. This configuration can prevent the harness H from coming into contact with a non-contactable member such as a movable portion and prevent an excessive force from acting on the harness H.

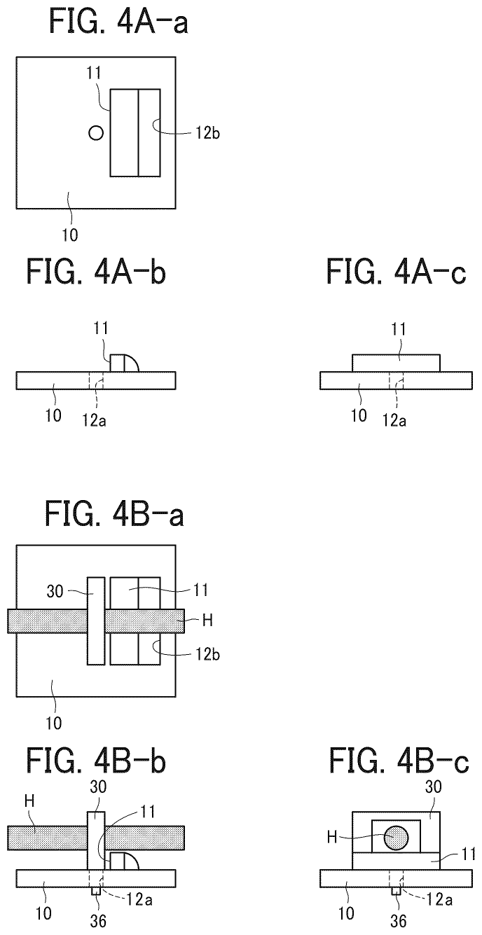

FIGS. 4A-a. 4A-b, 4A-c, 4B-a, 4B-b, and 4B-c illustrate a modification of the embodiments of the base 10.

Specifically, FIG. 4A-a is a plan view of the base 10 according to a modification of the embodiments.

FIG. 4A-b is a side view of the base 10 of FIG. 4A-a.

FIG. 4A-c is a front view of the base 10 of FIG. 4A-a.

FIG. 4B-a is a plan view of the base 10 according to a modification of the embodiments when the harness clamp 30 is attached to the base 10.

FIG. 4B-b is a side view of the base 10 of FIG. 4B-a.

FIG. 4B-c is a front view of the base 10 of FIG. 4B-a.

In this modification of the embodiments, a rectangular cutout hole 12b is formed on one side of the base 10, and the raised portion 11 is raised from the inner edge of the cutout hole 12b.

The raised portion 11 can be formed by cutting and raising an inner plate member of the cutout hole 12b.

This modification is preferable to dispose the harness clamp 30 and the raised portion at a position close to the center of the base 10.

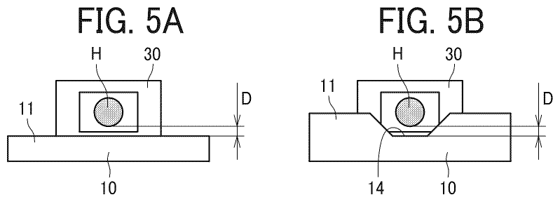

FIGS. 5A and 5B are diagrams each illustrating a relation of the height of a raised portion of the base 10 and the harness H according to the modification.

In this modification, a cutout portion 14 having a trapezoidal shape is formed in the center of the raised portion 11 in the longitudinal direction. Due to such a configuration, the harness H passes through a part of the cutout portion 14.

As a result, a sufficient gap D can be formed between the lowest portion of the cutout portion 14 and the harness H. Accordingly, the harness H can be prevented from being damaged by contacting with the raised portion 11 without changing the desired wiring path of the harness H. In other words, the raised portion 11 of the base 10 (planer base) has the cutout portion 14 (see FIGS. 5A and 5B) to form a gap between the raised portion 11 and the harness H to avoid an interference with the harness H.

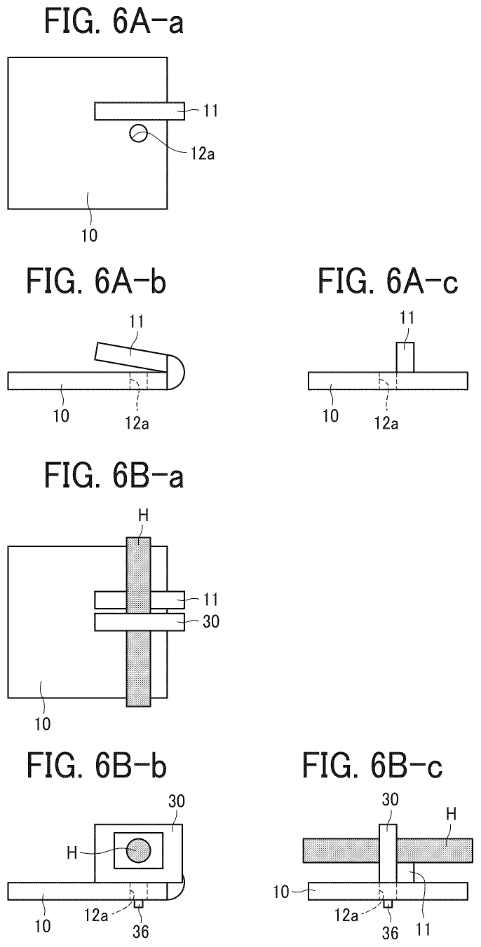

FIGS. 6A-a, 6A-b, 6A-c, 6B-a, 6B-b, and 6B-c illustrate the modification of the base 10.

Specifically, FIG. 6A-a is a plan view of the base 10 having the raised portion 11 according to the modification of the embodiments.

FIG. 6A-b is a side view of the base 10 of FIG. 6A-a.

FIG. 6A-c is a front view of the base 10 of FIG. 6A-a.

FIG. 6B-a is a plan view of the base 10 with the harness clamp 30 attached to the base 10.

FIG. 6B-b is a side view of the base 10 of FIG. 6B-a.

FIG. 6B-c is a front view of the base 10 of FIG. 6B-a.

In this modification, the raised portion 11 extends in the inward direction of the base as illustrated in FIGS. 6A-A, 6A-b, and 6A-c.

One shaft hole 12a penetrating the base 10 in the vertical direction is formed in the vicinity of the center in the longitudinal direction of the raised portion 11. The harness clamp for retaining the harness H is rotatably supported by the shaft hole 12a. This modification of the embodiments is preferable when the wiring path of the harness H is provided along the side end of the base 10.

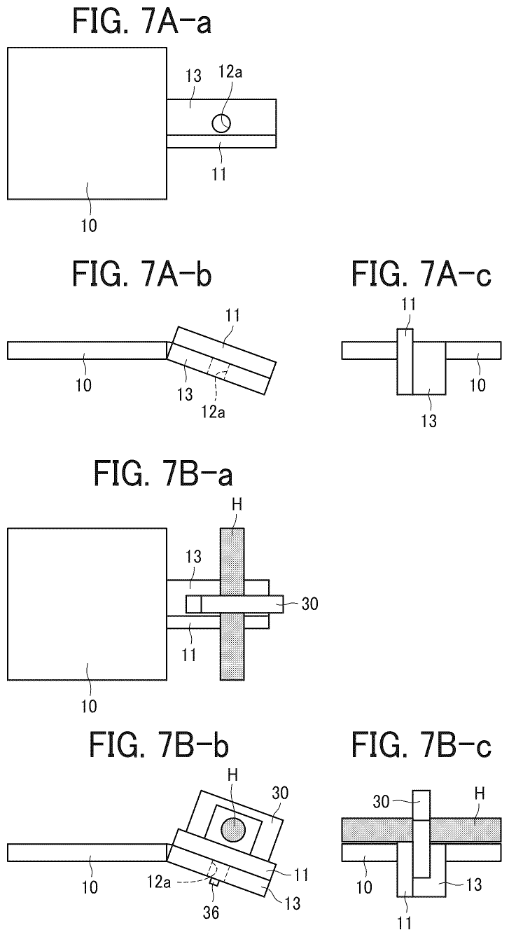

FIGS. 7A-a, 7A-b, 7A-c, 7B-a, 7B-b, and 7B-c illustrate another modification of the base 10.

Specifically, FIG. 7A-a is a plan view of the base 10 having the raised portion 11 according to a modification of the embodiments.

FIG. 7A-b is a side view of the base 10 of FIG. 7A-a.

FIG. 7A-c is a front view of the base 10 of FIG. 7A-a.

FIG. 7B-a is a plan view of the base 10 with the harness clamp 30 attached to the base 10.

FIG. 7B-b is a side view of the base 10 of FIG. 7B-a.

FIG. 7B-c is a front view of the base 10 of FIG. 7B-a.

In this modification, the raised portion 11 is formed along the arm 13 extending outward from the base 10.

The shaft hole 12a is the center of the arm 13 in the longitudinal direction. The harness clamp 30 is rotatably supported by the shaft hole 12a.

The arm 13 is tiltable with respect to the base 10. The arm 13 may extend in the horizontal direction or may extend slightly downward from the horizontal direction. The degree of freedom in the wiring path of the harness H can be increased by increasing or decreasing the inclination angle of the arm 13.

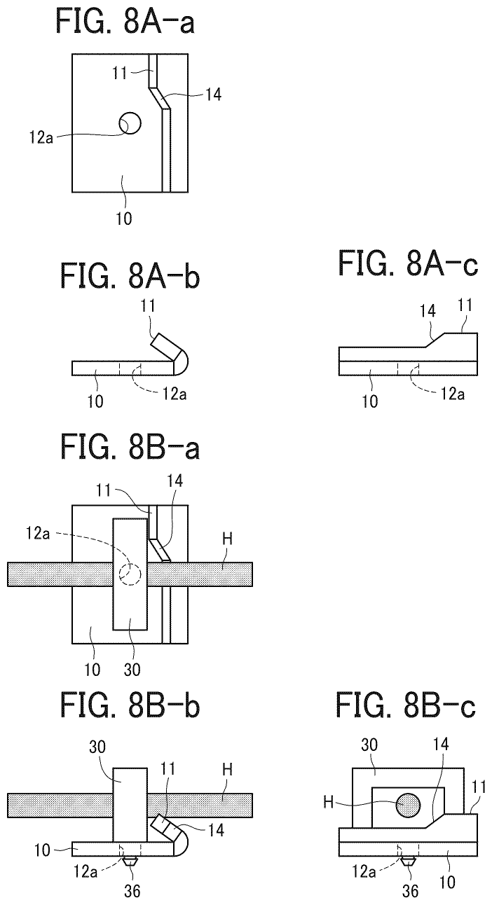

FIGS. 8A-a, 8A-b, 8A-c, 8B-a, 8B-b, and 8B-c illustrate yet another modification of the base 10.

Specifically, FIG. 8A-a is a plan view of the base 10 having the raised portion 11 according to a modification of the embodiments.

FIG. 8A-b is a side view of the base 10 of FIG. 8A-a.

FIG. 8A-c is a front view of the base 10 of FIG. 8A-a.

FIG. 8B-a is a plan view of the base 10 with the harness clamp 30 attached to the base 10.

FIG. 8B-b is a side view of the base 10 of FIG. 8B-a.

FIG. 8B-c is a front view of the base 10 of FIG. 8B-a.

In this modification of the embodiments, the raised portion 11, to be more specific, the tip portion of the raised portion 11 is formed only on one side of the base 10.

In other words, the cutout portion 14 is formed in most of the raised portion 11 extending linearly along one side of the base 10. By so doing, the extension range of the raised portion 11 is limited. The rotatable range of the harness clamp 30 is enlarged by the cutout portion 14.

In other words, in FIG. 8B-a, the harness clamp 30 is not rotatable in the clockwise direction, but is rotatable in the counterclockwise direction. This modification of the embodiments is preferable when the right end of the harness H in FIG. 8B-a is bent upward and routed.

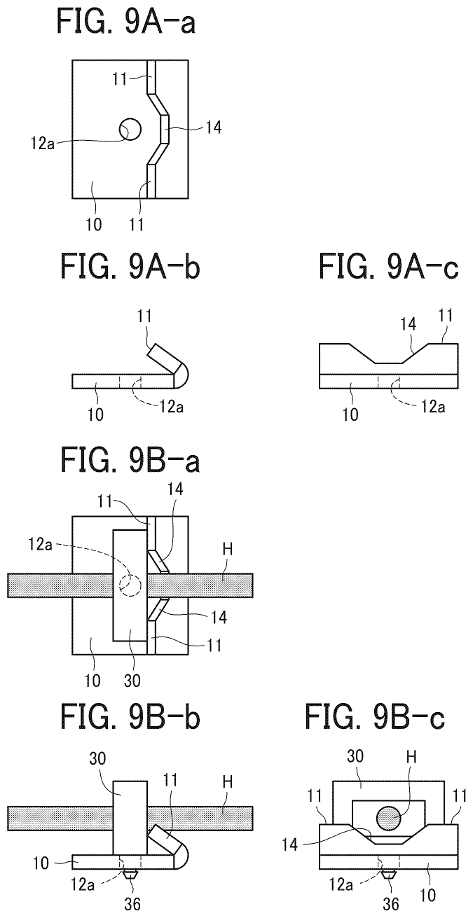

FIGS. 9A-a, 9A-b, 9A-c, 9B-a, 9B-b,and 9B-c illustrate yet another modification of the base 10.

Specifically, FIG. 9A-a is a plan view of the base 10 having the raised portion 11 according to a modification of the embodiments.

FIG. 9A-b is a side view of the base 10 of FIG. 9A-a.

FIG. 9A-c is a front view of the base 10 of FIG. 9A-a.

FIG. 9B-a is a plan view of the base with the harness clamp 30 attached to the base 10.

FIG. 9B-b is a side view of the base 10 of FIG. 9B-a.

FIG. 9B-c is a front view of the base 10 of FIG. 9B-a.

In this modification, the raised portion 11, to be more specific, the tip portion of the raised portion 11 is formed on opposite ends of the base 10, as a pair of raised portions 11. The cutout portion 14 is formed at a position between the raised portions 11 (pair of raised portions).

This modification is preferable to restrict the rotation of the harness clamp 30 in both the clockwise direction and the counterclockwise direction. Such a configuration can straighten the wiring path of the harness H.

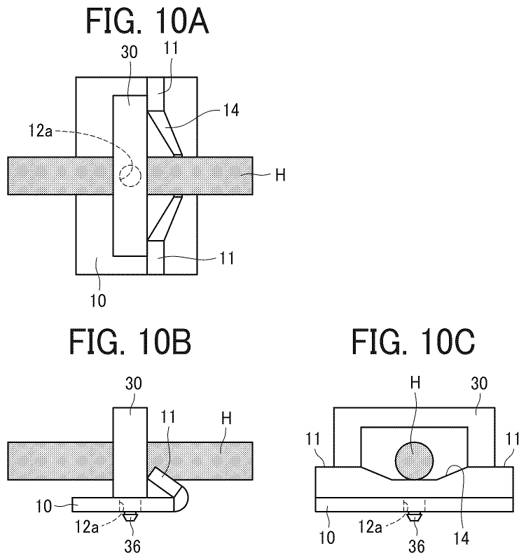

FIGS. 10A, 10B and 10C are diagrams illustrating the base 10 with the harness clamp 30 having a larger size (longer length).

Specifically, FIG. 10A is a plan view of the base 10 with the harness clamp of a different size from the above-described embodiments.

FIG. 10B is a side view of the base 10 of FIG. 10A.

FIG. 10C is a front view of the base 10 of FIG. 10A.

The base 10 and the pair of raised portions 11 in this modification are greater than the base 10 and the pair of raised portions 11 in FIGS. 9B-a, 9B-b and 9B-c, along with the harness clamp 30. The harness clamp 30 can also collectively retain multiple harnesses H.

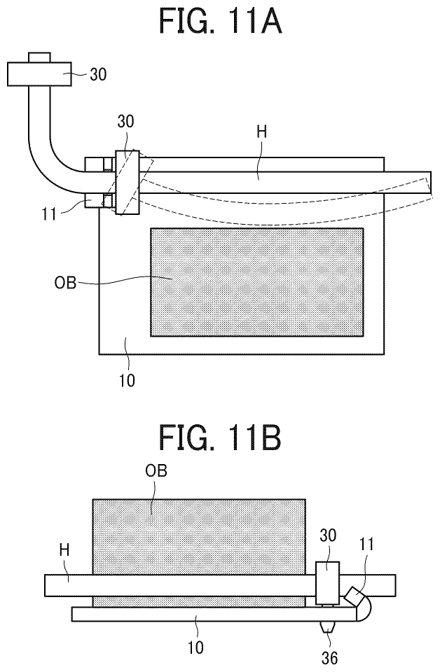

FIGS. 11A and 11B illustrate the base 10 with the harness clamp 30 on the side of a non-contactable member OB.

Specifically, FIG. 11A is a plan view of the harness holding structure 100 on the side of the non-contactable member OB.

FIG. 11B is a side view of the harness holding structure 100 of FIG. 11A.

The rotation of the harness clamp 30 is restricted by the raised portion 11 of the base 10, so that the wiring path of the harness H is restricted so as not to contact the non-contactable member OB.

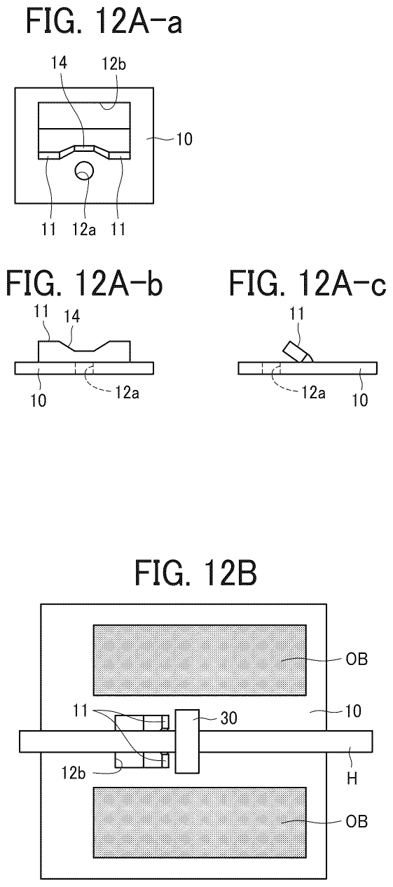

FIGS. 12A-a, 12A-b, 12A-c and 12B illustrate the base 10 when the rotation of the harness clamp 30 is restricted by the pair of raised portions 11 upwardly raised from the inner edge of the cutout hole 12b of the base 10.

Specifically, FIG. 12A-a is a plan view of the base 10 according to a modification of the embodiments.

FIG. 12A-b is a side view of the base 10 of FIG. 12A-a.

FIG. 12A-c is a front view of the base 10 of FIG. 12A-a.

FIG. 12B is a plan view of the base with the harness clamp 30 attached.

By restricting the rotation of the harness clamp 30 in both the clockwise direction and the counterclockwise direction by the pair of raised portions 11, the wiring path of the harness H is restricted so as not to hit the pair of uncontactable members OB as illustrated in, for example, 12B.

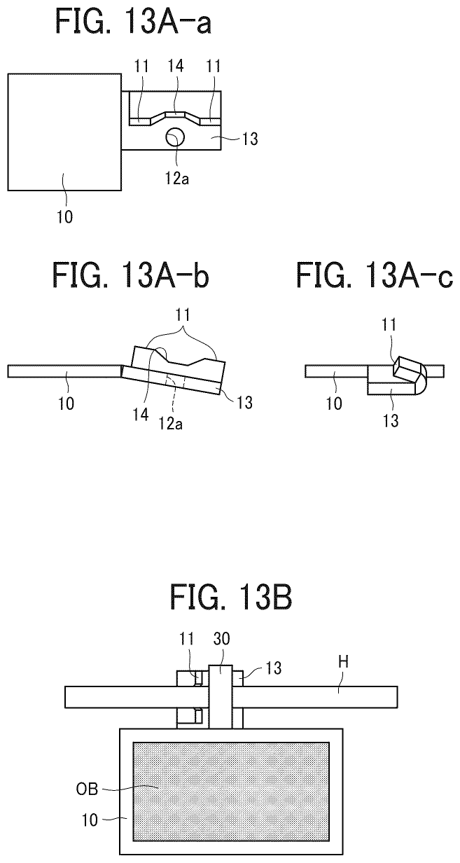

FIGS. 13A-a, 13A-b, 13A-c and 13B illustrate a configuration in which the raised portions 11 are formed along the arm 13 extending outward from the base 10, and the harness clamp 30 is rotatably supported by the shaft hole 12a of the arm 13.

Specifically, FIG. 13A-a is a plan view of the base 10 according to a modification of the embodiments.

FIG. 13A-b is a side view of the base 10 of FIG. 13A-a.

FIG. 13A-c is a front view of the base 10 of FIG. 13A-a.

FIG. 13B is a plan view of the base 10 with the harness clamp 30 attached to the base 10.

In this configuration, the harness clamp 30 can be separated away from the base 10, for example, as illustrated in FIG. 13B, and thus the length from the non-contactable member OB on the base 10 to the harness H can be increased.

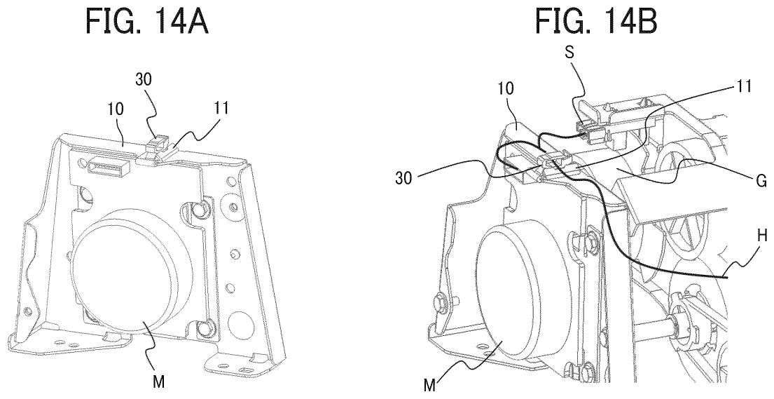

FIGS. 14A and 14B are perspective views of a motor M including the harness holding structure 100 according to an embodiment of the present disclosure.

Specifically, FIGS. 14A and 14B are perspective views of an example in which the harness clamp 30 is disposed around the motor M and a sensor S.

A non-contact member such as a gear G is disposed near the motor M. The wiring path of the harness H drawn out from the motor M and the sensor S is set by the harness clamp 30 so as not to contact with the non-contact member such as the gear G.

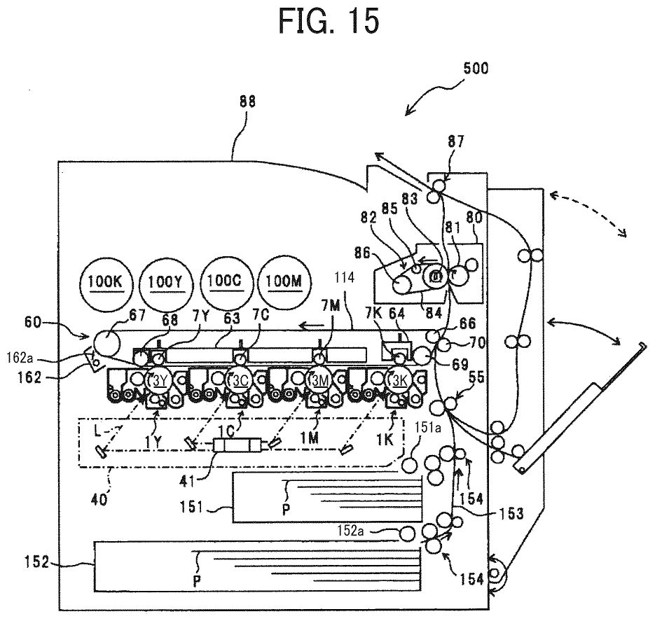

A description is given of an image forming apparatus according to the present disclosure, with reference to FIG. 15.

FIG. 15 is a diagram illustrating an overall configuration of an image forming apparatus 500 including the harness holding structure 100 as a harness holder according to an embodiment of the present disclosure.

The image forming apparatus 500 includes four image forming units 1Y, 1C, 1M, and 1K for yellow, magenta, cyan, and black (hereinafter may be described as Y, C, M, and K). These image forming units use Y, C, M, and K toners having different colors from one another as image forming substances for forming images, but are identical with one another in the other respects.

A transfer unit 60 including an intermediate transfer belt 114 serving as an intermediate transfer medium is disposed above the four image forming units 1Y, 1C, 1M, and 1K. In this configuration, toner images of the respective colors formed on the surfaces of photoconductors 3Y, 3C, 3M, and 3K included in the image forming units 1Y, 1C, 1M, and 1K to be described in detail below are transferred to the surface of the intermediate transfer belt 114 in an overlaying manner.

An optical writing unit 40 is disposed below the four image forming units 1Y, 1C, 1M, and 1K. The optical writing unit 40 serving as a latent image forming unit irradiates the photoconductors 3Y, 3C, 3M, and 3K of the image forming units 1Y, 1C, 1M, and 1K with laser light L generated based on image information. As a result, electrostatic latent images for Y, C, M, and K are formed on the photoconductors 3Y, 3C, 3M, and 3K. While deflecting laser light L emitted from a light source by a polygon mirror 41 driven to rotate by a motor, the optical writing unit 40 irradiates the photoconductors 3Y, 3C, 3M, and 3K with the laser light L through multiple optical lenses and mirrors. Instead of this configuration, a configuration for performing laser scan by an LED array may be employed.

A first sheet tray 151 and a second sheet tray 152 are disposed below the optical writing unit 40 in a vertically stacked state. Recording media P overlaid in the form of a paper bundle are stored in each of the sheet trays. A first sheet feed roller 151a and a second sheet feed roller 152a are in contact with the uppermost recording media P, respectively. When the first sheet feed roller 151a is driven to rotate counterclockwise in FIG. 4 by a drive unit, the uppermost recording medium P in the first sheet tray 151 is sent out to a sheet conveyance path 153 provided in an extending manner in the vertical direction at the right-hand side of the cassette in FIG. 4. When the second sheet feed roller 152a is driven to rotate counterclockwise in FIG. 4 by a drive unit, the uppermost recording medium P in the second sheet tray 152 is sent out to the sheet conveyance path 153.

Multiple conveyance roller pairs 154 are disposed in the sheet conveyance path 153. A recording medium P sent to the sheet conveyance path 153 is conveyed through the sheet conveyance path 153 bottom upward in FIG. 4, being sandwiched between the rollers of the conveyance roller pairs 154.

Multiple registration roller pairs 55 are disposed at a downstream end of the sheet conveyance path 153 in the conveying direction. The registration roller pairs 55 once stop rotating immediately after the registration roller pairs 55 catch the recording medium P sent from the conveyance roller pairs 154 between the registration roller pairs 55. Then, the registration roller pairs 55 send out the recording medium P to a secondary transfer nip described below at an appropriate timing.

The transfer unit 60 serving as a transfer unit illustrated in FIG. 4 includes, for example, a belt cleaning unit 162, a first bracket 63, and a second bracket 64 in addition to the intermediate transfer belt 114. The transfer unit 60 also includes, for example, four primary transfer rollers 7Y, 7C, 7M, and 7K, a secondary transfer backup roller 66, a drive roller 67, an auxiliary roller 68, and a tension roller 69. The intermediate transfer belt 114 is endlessly moved counterclockwise in FIG. 4, being driven to rotate by the drive roller 67 and hung on these eight roller members in a tense state. The four primary transfer rollers 7Y, 7C, 7M, and 7K form primary transfer nips by nipping the endlessly moved intermediate transfer belt 114 between themselves and the photoconductors 3Y, 3C, 3M, and 3K. The primary transfer rollers apply a transfer bias having a polarity (e.g., positive) opposite to the toner to the back surface (internal circumferential surface of the loop) of the intermediate transfer belt 114. As the intermediate transfer belt 114 sequentially passes the primary transfer nips for Y, C, M, and K along with the endless movement thereof, Y, C, M, and K toner images on the photoconductors 3Y, 3C, 3M, and 3K are primarily transferred to the external surface of the intermediate transfer belt 114 in an overlaid state. As a result, a four color-overlaid toner image (hereinafter, may be referred to as four-color toner image) is formed on the intermediate transfer belt 114.

The secondary transfer backup roller 66 forms a secondary transfer nip by nipping the intermediate transfer belt 114 between itself and a secondary transfer roller 70 disposed outside the loop of the intermediate transfer belt 114. The registration roller pairs 55 described above send out the recoding medium P sandwiched between the registration roller pairs 55 to the secondary transfer nip at a timing at which the recording medium P can be synchronous with the four-color toner image on the intermediate transfer belt 114. Due to influences of a secondary transfer electric field formed between the secondary transfer roller 70 to which a secondary transfer bias is applied and the secondary transfer backup roller 66, and a nip pressure, the four-color toner image on the intermediate transfer belt 114 is secondarily transferred collectively to the recording medium P in the secondary transfer nip. Then, being mixed with the white color of the recording medium P, the four-color toner image becomes a full-color toner image.

A remaining toner left untransferred to the recording medium P is adhering to the intermediate transfer belt 114 that has passed the secondary transfer nip. The remaining toner is cleaned by the belt cleaning unit 162. The belt cleaning unit 162 is configured to scrape away and remove the remaining toner on the intermediate transfer belt 114 by the belt cleaning blade 162a, which contacts the external surface of the intermediate transfer belt 114.

The first bracket 63 of the transfer unit 60 is configured to sway at a predetermined rotation angle about the rotation axis of the auxiliary roller 68 along with on and off of solenoid driving. When forming a monochrome image, the image forming apparatus 500 slightly rotates the first bracket 63 counterclockwise in FIG. 4 by driving the solenoid. By this rotation, the primary transfer rollers 7Y, 7C, and 7M for Y, C, and M revolve about the rotation axis of the auxiliary roller 68 counterclockwise in FIG. 4, to separate the intermediate transfer belt 114 from the photoconductors 3Y, 3C, and 3M for Y, C, and M. Then, among the four image forming units 1Y, 1C, 1M, and 1K, only the image forming unit 1K for K is driven to form a monochrome image. This makes it possible to avoid wearing of each member constituting the image forming units 1Y, 1C, 1M, and 1K for Y, C, and M due to wastefully driving these image forming units 1Y, 1C, 1M, and 1K during formation of a monochrome image.

A fixing unit 80 is disposed above the secondary transfer nip in FIG. 4. The fixing unit 80 includes a pressurizing heating roller 81 internally including a heat generation source such as a halogen lamp, and a fixing belt unit 82. The fixing belt unit 82 includes, for example, a fixing belt 84 serving as a fixing member, a heating roller 83 internally including a heat generation source such as a halogen lamp, a tension roller 85, a drive roller 86, and a temperature sensor. The fixing belt 84 having an endless shape is endlessly moved counterclockwise in FIG. 4, being hung on the heating roller 83, the tension roller 85, and the drive roller 86 in a tense state. Along with this endless movement, the fixing belt 84 is heated on the back surface by the heating roller 83. The pressurizing heating roller 81, which is driven to rotate clockwise in FIG. 4, contacts the external surface of the fixing belt 84 heated in this way, at a portion of the fixing belt 84 hung on the heating roller 83. As a result, a fixing nip at which the pressurizing heating roller 81 and the fixing belt 84 contact each other is formed.

The temperature sensor is disposed outside the loop of the fixing belt 84 in a manner to face the external surface of the fixing belt 84 via a predetermined gap, and configured to sense the surface temperature of the fixing belt 84 immediately before entering the fixing nip. The sensing result is sent to a fixing power source circuit. Based on the sensing result of the temperature sensor, the fixing power source circuit controls turning on or off power supply to the heat generation source internally included in the heating roller 83 and the heat generation source internally included in the pressurizing heating roller 81.

The recording medium P that has passed the secondary transfer nip described above is separated from the intermediate transfer belt 114 and then sent into the fixing unit 80. The recording medium P is heated and pressurized by the fixing belt 84 along with being conveyed bottom upward in FIG. 4 being nipped by the fixing nip in the fixing unit 80. As a result, the full-color toner image is fixed on the recording medium P.

The recording medium P that has undergone the fixing process in this way passes between the rollers of a pair of paper ejecting rollers 87, and is then ejected to outside the apparatus. A stack portion 88 is formed on the upper surface of the housing of the image forming apparatus 500 body. The recording medium P ejected to outside the apparatus by the pair of paper ejecting rollers 87 is sequentially stacked on the stack portion 88.

Four toner cartridges 100Y, 100C, 100M, and 100K storing Y, C, M, and K toners are disposed above the transfer unit 60. The Y, C, M, and K toners in the toner cartridges 100Y, 100C, 100M, and 100K are appropriately supplied into the developing devices 5Y, 5C, 5M, and 5K of the image forming units 1Y, 1C, 1M, and 1K. These toner cartridges 100Y, 100C, 100M, and 100K are attachable on and detachable from the image forming apparatus body independently from the image forming units 1Y, 1C, 1M, and 1K.

The above-described embodiments are illustrative and do not limit the present disclosure. It is therefore to be understood that within the scope of the appended claims, numerous additional modifications and variations are possible to this disclosure otherwise than as specifically described herein. In other words, for example, the harness clamp 30 is not limited to have the shape illustrated in FIGS. 3A and 3B, and may have any shape and structure that can clamp (hold) the harness H. The raised portion 11 of the base 10 may be formed on opposite edges of the base 10.

The following describes preferred aspects of the present disclosure.

### Aspect 1

In Aspect 1, a harness holder includes a harness clamp and a base. The harness clamp clamps a harness. The base of a planar shape, to which the harness clamp is rotatably attached. The base has a raised portion that is a bent and raised part of the base. The raised portion is within a rotation range of the harness clamp.

### Aspect 2

In Aspect 2, in the harness holder according to Aspect 1, the harness clamp includes a shaft. The base has a shaft opening. The shaft of the harness clamp is rotatably inserted into the shaft opening of the base.

### Aspect 3

In Aspect 3, in the harness holder according to Aspect 1, the raised portion is disposed facing the shaft opening.

### Aspect 4

In Aspect 4, in the harness holder according to Aspect 1, the base has a cutout opening. The raised portion is bent upward from an inner edge of the cut opening.

### Aspect 5

In Aspect 5, in the harness holder according to Aspect 1, the base includes an arm outwardly extending from an end of the base. The arm has the raised portion and a shaft opening.

### Aspect 6

In Aspect 6, in the harness holder according to Aspect 5, the arm is tiltable with respect to the base.

### Aspect 7

In Aspect 7, in the harness holder according to any one of Aspects 1 to 6, the raised portion of the base has a cutout to avoid an interference with the harness.

### Aspect 8

In Aspect 8, in the harness holder according to Aspect 7, the cutout has a tip of the raised portion on each of opposite ends of the cutout.

### Aspect 9

In Aspect 9, in the harness holder according to Aspect 7, the cutout has a tip of the raised portion on one end of the cutout.

### Aspect 10

In Aspect 10, an image forming apparatus includes the harness holder according to any one of Aspects 1 to 9.

### Aspect 11

In Aspect 11, a harness holder includes a harness clamp and a planar base. The harness clamp has a shaft and a clamp portion to clamp a harness. The base has a shaft hole and a raised portion. The shaft hole is used to insert the shaft of the harness clamp. The raised portion has a part bent and raised from the planer base. The harness clamp attached to the planer base is rotatable about the shaft. The raised portion is disposed within a rotation range of the harness clamp on the planer base.

### Aspect 12

In Aspect 12, in the harness holder according to Aspect 11, the raised portion has a height, from the planer base, higher than a lower edge of the clamp portion of the harness clamp having the shaft inserted into the shaft hole of the planer base, and lower than a lower edge of the harness clamped by the harness clamp.

### Aspect 13

In Aspect 13, in the harness holder according to Aspect 11, the raised portion faces the clamp portion of the harness clamp attached to the planer base.

### Aspect 14

In Aspect 14, in the harness holder according to Aspect 11, the planer base has a cutout opening. The raised portion is bent and raised from an inner edge of the cut opening.

### Aspect 15

In Aspect 15, in the harness holder according to Aspect 11, the planer base includes an arm having the raised portion and the shaft hole. The arm extends outside the planer base from an end of the planer base.

### Aspect 16

In Aspect 16, in the harness holder according to Aspect 15, the arm is inclined with respect to a plan of the planer base.

### Aspect 17

In Aspect 17, in the harness holder according to any one of Aspects 11 to 16, the raised portion of the planer base has a cutout to form a gap between the raised portion and the harness.

### Aspect 18

In Aspect 18, in the harness holder according to Aspect 17, the raised portion has a tip, contactable with the clamp portion, outside of each opposite ends of the cutout.

### Aspect 19

In Aspect 19, in the harness holder according to Aspect 17, the raised portion has a tip, contactable with the clamp portion, outside of one end of the cutout.

### Aspect 20

In Aspect 20, an image forming apparatus includes the harness holder according to any one of Aspects 11 to 19.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

What is claimed is:

1. A harness holder comprising:
a harness clamp having:
a shaft; and
a clamp portion to clamp a harness; and
a planer base having:
a shaft hole to insert the shaft of the harness clamp; and
a raised portion having a part bent and raised from the planer base,
wherein the harness clamp attached to the planer base is rotatable about the shaft, and
the raised portion is disposed within a rotation range of the harness clamp on the planer base.

2. The harness holder according to claim 1,
wherein the raised portion has a height, from the planer base,
higher than a lower edge of the clamp portion of the harness clamp having the shaft inserted into the shaft hole of the planer base; and
lower than a lower edge of the harness clamped by the harness clamp.

3. The harness holder according to claim 1,
wherein the raised portion faces the clamp portion of the harness clamp attached to the planer base.

4. The harness holder according to claim 1,
wherein the planer base has a cutout opening, and
the raised portion is bent and raised from an inner edge of the cut opening.

5. The harness holder according to claim 1,
wherein the planer base includes an arm having the raised portion and the shaft hole, and
the arm extends outside the planer base from an end of the planer base.

6. The harness holder according to claim 5,
wherein the arm is inclined with respect to a plan of the planer base.

7. The harness holder according to claim 1,
wherein the raised portion of the planer base has a cutout to form a gap between the raised portion and the harness.

8. The harness holder according to claim 7,
wherein the raised portion has a tip, contactable with the clamp portion, outside of each opposite ends of the cutout.

9. The harness holder according to claim 7,
wherein the raised portion has a tip, contactable with the clamp portion, outside of one end of the cutout.

10. An image forming apparatus comprising the harness holder according to claim 1.
